(19) United States
(12) Patent Application Publication
(10) Pub. No.: US 2009/0315860 A1
(43) Pub. Date: Dec. 24, 2009

(54) TOUCH CONTROL PEN ASSEMBLY

(76) Inventors: Mei-Ling Lee, Taipei County (TW); Huei-Wen Yeh, Taipei County (TW); Yin-Yu Chen, Taipei County (TW)

Correspondence Address: Mei-Ling Lee, 235 Chung - Ho, Box 8-24, Taipei, 235, TW

(21) Appl. No.: 12/141,090

(22) Filed: Jun. 18, 2008

(51) Int. Cl. G06F 3/033

(52) U.S. Cl. 345/179

(57) ABSTRACT

A touch control pen assembly comprises a pen head including a touch head and the base; the touch head being placed in the base; one end of the touch head having a spring; a rear end of the touch head being formed with an annular groove for receiving the spring so as to form as the pen head; when the touch head being pressed downwards, the spring providing a buffer force to the touch head; and a pen shaft assembly connected to a rear end of the pen head for extending a length of the pen head so that a user can hold the pen conveniently. The pen head is detachable to be used with pen shaft assembly of different types. The spring at one end of the touch head will provides a buffer force for a pressed touch head so that the pen has uniform pointing forces.

### FIELD OF THE INVENTION

The present invention relates to touch control pens, and particularly to a touch control pen assembly, wherein the pen head is detachable to be used with pen shaft assemblies of different types. A spring at one end of the touch head will provides a buffer force for a pressed touch head so that the pen has uniform pointing forces. Thus the present invention is inventive.

### BACKGROUND OF THE INVENTION

The technology of touch panel has been well developed and is used in the daily life, such as the applications of ATMs, handsets, game machines, personal digital assistances (PDAs), etc. However the touch panels are pointed by dedicated touch pens.

The prior art touch pens have the defects of unique specifications which are not suitable for the necessity of markets. Furthermore, if the force for pointing is not uniform, the display of the touch panel will destroy and the cost is high.

### SUMMARY OF THE INVENTION

To achieve above object, the present invention provides a touch control pen assembly, wherein the pen head is detachable to be used with pen shaft assembly of different types. A spring at one end of the touch head will provides a buffer force for a pressed touch head so that the pen has uniform pointing forces. Thus the present invention is inventive.

Accordingly, the object of the present invention is to provide a touch control pen assembly, comprising: a pen head including a touch head and the base; the touch head being placed in the base; one end of the touch head having a spring; a rear end of the touch head being formed with an annular groove for receiving the spring so as to form as the pen head; when the touch head being pressed downwards, the spring providing a buffer force to the touch head; and a pen shaft assembly connected to a rear end of the pen head for extending a length of the pen head so that a user can hold the pen conveniently.

A bottom end of the base is formed with an annular recess for embedding the pen shaft assembly. A rear end of the base of the pen head is reduced inwards so as to form as a connecting head for combining with the pen shaft assembly.

The various objects and advantages of the present invention will be more readily understood from the following detailed description when read in conjunction with the appended drawing.

### BRIEF DESCRIPTION OF THE DRAWINGS

FIG. 1 is an exploded perspective view of the present invention.

FIG. 2 is an assembled perspective view of the present invention.

FIG. 3 is a structural exploded view of the pen head of the present invention.

FIG. 4 is a structural cross sectional view of the pen head of the present invention.

FIG. 5 is a cross sectional view of the pen head of the present invention.

FIG. 6 is another structural cross sectional view of the pen head of the present invention.

FIG. 7 shows another embodiment of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

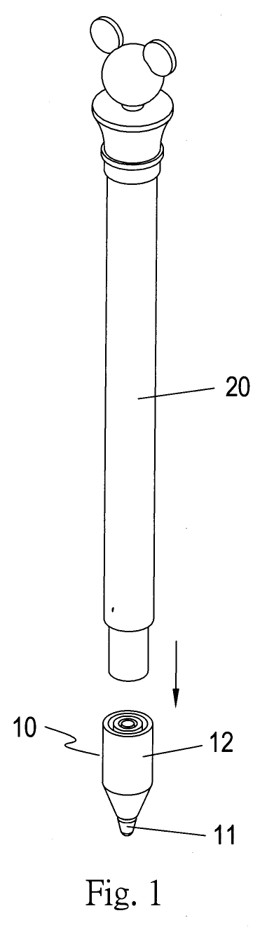

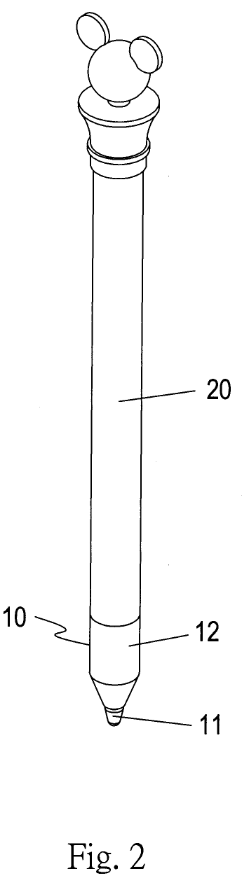

The touch control pen assembly of the present invention is illustrated in FIGS. 1 and 2 which are exploded perspective view and assembled view of the present invention. The pen assembly has the following elements.

A pen head 10 includes a touch head 11 and a base 12. The touch head 11 is placed in the base 12.

A pen shaft assembly 20 is connected to a rear end of the pen head 10 for extending a length of the pen head 10 so that the user can hold the pen shaft assembly 20 conveniently.

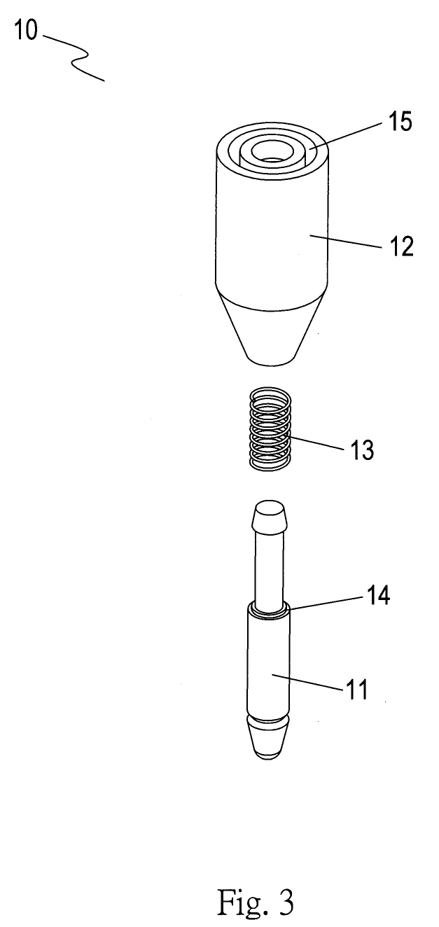

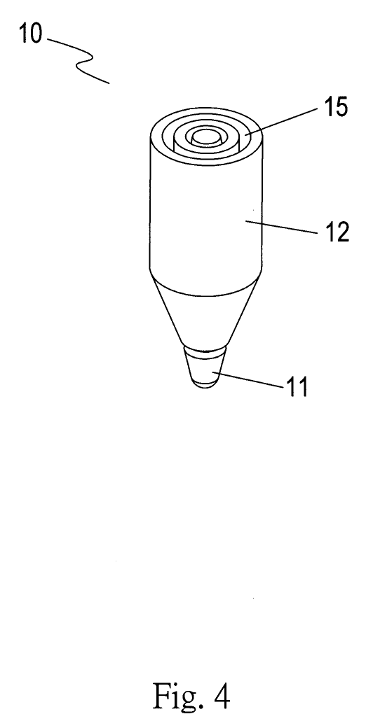

Referring to FIG. 3, the exploded perspective view about the pen head 10 is illustrated. The pen head 10 includes the touch head 11 and the base 12. The touch head 11 is placed in the base 12. One end of the touch head 11 has a spring 13. A rear end of the touch head 11 is formed with an annular groove 14 for receiving the spring 13 so as to form as the pen head 10. FIG. 4 shows the assembly view. It is illustrated at a bottom end of the base 12 is formed with an annular recess 15 for embedding the pen shaft assembly 20.

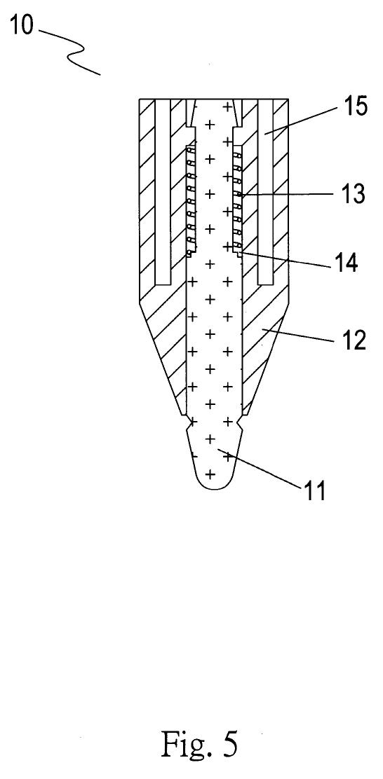

Referring to FIG. 5, the cross sectional view of the pen head 10 of the present invention. When the touch head 11 is pressed downwards, the spring 13 in the annular groove 14 will provide a resilient force to the pressed touch head 11 so that the pen has a uniform pointing force. Thus the present invention is inventive.

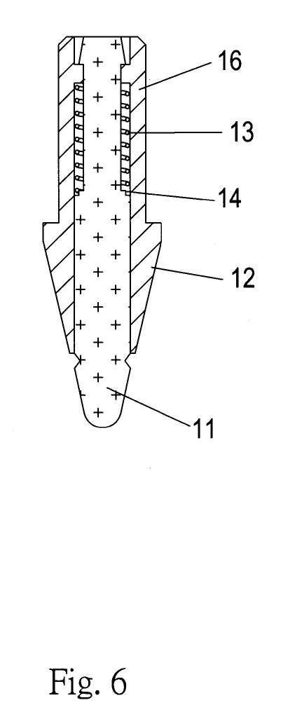

Referring to FIG. 6, another structural cross sectional view of the pen head of the present invention is illustrated. In that a rear end of the base 12 of the pen head 10 is reduced inwards so as to form as a connecting head 16 for combining with the pen shaft assembly 20.

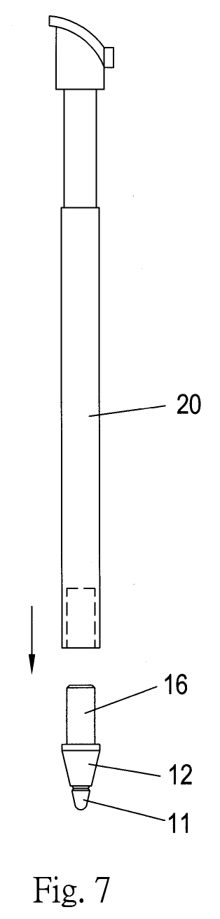

Referring to FIG. 7, another embodiment of the pen head of the present invention is illustrated. In this embodiment, the present invention is modularized. In that the pen head 10 is detachable for combining with pen shaft assemblies of different types. The spring of the pen head 10 may be formed by different elastic material.

Advantage of the present invention will be described herein.

The present invention has a modularized design. The detachable pen head may be used with pen shaft assembly of different types.

In the present invention, the spring at one end of the touch head will provides a buffer force for a pressed touch head so that the pen has uniform pointing forces. Thus the present invention is inventive.

The present invention is suitable for environmental protection. The technology of precise module is sued to have a tight matching effect to the present invention so that the material is saved.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A touch control pen assembly, comprising:
a pen head including a touch head and the base; the touch head being placed in the base; one end of the touch head having a spring; a rear end of the touch head being formed with an annular groove for receiving the spring so as to form as the pen head; when the touch head being pressed downwards, the spring providing a buffer force to the touch head;
a pen shaft assembly connected to a rear end of the pen head for extending a length of the pen head so that a user can hold the pen conveniently.

2. The touch control pen assembly as claimed in claim 1, wherein a bottom end of the base is formed with an annular recess for embedding the pen shaft assembly.

3. The touch control pen assembly as claimed in claim 1, wherein a rear end of the base of the pen head is reduced inwards so as to form as a connecting head for combining with the pen shaft assembly.
